(19) United States
(12) Patent Application Publication
(10) Pub. No.: US 2024/0376320 A1
(43) Pub. Date: Nov. 14, 2024

(54) SOLUTIONS AND GELS OF ONE-DIMENSIONAL METAL OXIDES

(71) Applicant: Arizona Board of Regents on behalf of Arizona State University, Scottsdale, AZ (US)

(72) Inventors: David Ciota, Scottsdale, AZ (US); Dong-Kyun Seo, Chandler, AZ (US); Tam Nguyen, Tempe, AZ (US)

(21) Appl. No.: 18/692,115

(22) PCT Filed: Nov. 22, 2022
(86) PCT No.: PCT/US2022/050770

§ 371 Date: Mar. 14, 2024

Related U.S. Application Data
(60) Provisional application No. 63/282,032, filed on Nov. 22, 2021.

(51) Int. Cl. C09D 1/00; C08K 3/30; C08K 3/32; C09D 7/20

(52) U.S. Cl. CPC C09D 1/00; C09D 7/20; C08K 2003/3045; C08K 2003/328

(57) ABSTRACT

Preparing a metal-containing solution or gel includes combining a metal oxide and a liquid comprising a polar organic solvent to yield a mixture, wherein the metal oxide comprises hydrogen-bonded molecular chains, and each molecular chain comprises: a metal from Groups 4-6; at least one oxyanion of a main group element from Groups 15 and 16 bound to the metal through a polar covalent bond, wherein the at least one oxyanion is optionally protonated; and at least one water molecule bound to the metal through a polar covalent bond; and heating the mixture to yield a solution or gel comprising the polar organic solvent and the metal. The solution or gel can be acidic.

### CROSS-REFERENCE TO RELATED APPLICATION

This application claims the benefit of U.S. Patent Application No. 63/282,032 filed on Nov. 22, 2021, which is incorporated herein by reference in its entirety.

### TECHNICAL FIELD

This invention relates to one-dimensional metal oxides and their modifications.

### BACKGROUND

Solutions and gels of metal oxides have extensive uses as precursors that allow preparation of metal oxides in various forms including nanoparticles, porous materials, powder, films, coatings, and monoliths. Sols and gels of metal oxides are typically prepared by using sol-gel processes with metal precursor solutions in water at ambient temperatures and pressures. Known stable solutions of metal oxides include solutions of hydrates of metal salts (e.g., AlCl₃·6H₂O and NiCl₂·6H₂O). An aqueous solution of a metal salt can be treated with a hydroxide solution to form a (hydrous) metal hydroxide precipitate, which can then be collected and calcined to produce a metal oxide. Amorphous silica (SiO₂) is an archetype of metal oxides that is prepared extensively by sol-gel processes.

### SUMMARY

An acidic solution or gel of a metal oxide in an organic solvent and a process of making the acidic solution or gel are disclosed. Formation of the solution or gel is carried out by dissolving bulk particles of metal oxides in a polar organic solvent under a mild condition. The dissolution of the metal oxide in the organic solvent does not require hydrolysis of the metal oxide. The metal oxide includes a compound whose chemical structure contains inorganic molecular chains. During the dissolution of the bulk particles, the molecular chains are separated from each other to form nanostructures or sub-nanostructures dissolved in the solvent medium. Once a solution or gel is formed, the nanostructures or sub-nanostructures can be collected, using a variety of techniques to yield products including but not limited to the nanostructures, sub-nanostructures, inorganic-organic hybrid materials, inorganic-inorganic hybrid materials, inorganic-biogenic hybrid materials, and inorganic-biological hybrid materials. They can be prepared in various forms including but not limited to nanoparticles, porous materials, powder, films, coatings, and monoliths.

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.

Embodiment 1 is a method of preparing a metal-containing solution or gel, the method comprising:
combining a metal oxide and a liquid comprising a polar organic solvent to yield a mixture, wherein the metal oxide comprises hydrogen-bonded molecular chains, and each molecular chain comprises:
   a metal from Groups 4-6;
   at least one oxyanion of a main group element from Groups 15 and 16 bound to the metal through a polar covalent bond, wherein the at least one oxyanion is optionally protonated; and
   at least one water molecule bound to the metal through a polar covalent bond; and heating the mixture to yield a solution or gel comprising the polar organic solvent and the metal.

Embodiment 2 is the method of embodiment 1, wherein the solution or gel is combined with an additional liquid miscible with the polar organic solvent or a solid soluble in the polar organic solvent to yield another solution or gel.

Embodiment 3 is the method of embodiment 2, wherein the additional liquid comprises sulfuric acid.

Embodiment 4 is the method of any one of embodiments 1-3, further comprising removing the polar organic solvent from the solution or gel to yield a material in the form of a liquid, semi-liquid, semi-solid, solid, coating, thin film, monolith, or powder.

Embodiment 5 is the method of embodiment 4, wherein the material comprises nanostructures, sub-nanostructures, or a combination thereof.

Embodiment 6 is the method of embodiments 4 or 5, wherein the material is an inorganic material, inorganic-organic hybrid material, inorganic-inorganic hybrid material, inorganic-biogenic hybrid material, inorganic-biological hybrid material, or a combination thereof.

Embodiment 7 is the method of any one of embodiments 4-6, further comprising treating the material to modify a chemical structure, a chemical composition, or both of the material.

Embodiment 8 is the method of embodiment 7, wherein treating the material comprises heating the material to a temperature above 50° C., 60° C., 70° C., 80° C., 90° C., 100° C., 200° C., 300° C., 400° C., 500° C., 600° C., 700° C., 800° C., 900° C., 1000° C., 1100° C., 1200° C., 1300° C., 1400° C., or 1500° C. in the presence of air, oxygen gas, hydrogen gas, nitrogen gas, argon gas, or a combination thereof.

Embodiment 9 is the method of any one of embodiments 6-8, wherein the material is a coating or a thin film, and treating the coating or thin film comprises contacting the coating or thin film with a chemical compound selected to increase a pH of the solution or gel.

Embodiment 10 is the method of any one of embodiments 1-9, further comprising:
combining the solution or gel with a chemical compound to yield solid particles; and
collecting the solid particles to yield a powder material.

Embodiment 11 is the method of any one of embodiments 1-10, The method of claim 1, wherein the metal oxide has an empirical formula of HₓM_{y}X_{z}O_{w} wherein H is hydrogen, M is a metal element chosen from Groups 4-6 or a doped variant thereof, X is a main group element chosen from Groups 15 and 16 or a doped variant thereof, O is oxygen, x/y ranges from 0.5 to 2, from 0.5 to 3, or from 0.5 to 6 and y/z ranges from 0.5 to 3, from 0.5 to 1, or from 0.5 to 3.

Embodiment 12 is the method of any one of embodiments 1-11, wherein the solution or gel comprises, in unbound form, the oxyanion, a conjugate acid of the oxyanion, or both.

Embodiment 13 is the method of any one of embodiments 1-12, wherein at least half of a total number of metal atoms in the metal oxide have a formal oxidation state of 4+, 5+, or 6+.

Embodiment 14 is the method of any one of embodiments 1-13, wherein the metal oxide comprises phosphate, biphosphate, sulfate, bisulfate, or any combination thereof.

Embodiment 15 is the method of any one of embodiments 1-14, wherein the metal oxide comprises TiOSO₄·2H₂O or a doped variant thereof.

Embodiment 16 is the method of any one of embodiments 1-15, wherein the solution or gel comprises an organic polymer, and the organic polymer is soluble in the polar organic solvent.

Embodiment 17 is the method of any one of embodiments 1-16, wherein heating the mixture comprises heating the mixture electromagnetically, with a thermal heat flux, or both.

Embodiment 18 is the method of any one of embodiments 1-17, further comprising stirring, shaking, or agitating the mixture.

Embodiment 19 is the method of any one of embodiments 1-18, wherein a viscosity of the solution or gel at 25° C. is at least 2, 5, 10, 50, 100, 500, 1000, 5000, or 10000 times greater than a viscosity of the polar organic solvent at 25° C.

Embodiment 20 is the method of any one of embodiments 1-19, wherein the polar organic solvent has a dielectric constant of at least 25, 30, 35, 40, 45, 50, 55, 60, 70, 80, 90, or 100 and a dipole moment of at least 1.5 D, 2 D, 2.5 D, 3 D, 3.5 D, 4 D, or 5 D.

Embodiment 21 is the method of any one of embodiments 1-20, wherein the polar organic solvent comprises methanol, ethanol, formamide, N-methyl formamide, N, N-dimethyl formamide, dimethyl sulfoxide, or any combination thereof.

Embodiment 22 is the method of any one of embodiments 1-20, wherein the metal oxide comprises TiOSO₄·2H₂O or a doped variant thereof, and the polar organic solvent comprises methanol, ethanol, formamide, N-methyl formamide, N, N-dimethyl formamide, dimethyl sulfoxide, or any combination thereof.

Embodiment 23 is the method of any one of embodiments 1-20, wherein the metal oxide comprises MoO₂(HPO₄)·H₂O or a doped variant thereof, and the polar organic solvent comprises formamide, N-methyl formamide, N, N-dimethyl formamide, dimethyl sulfoxide, or any combination thereof.

Embodiment 24 is the method of any one of embodiments 1-23, wherein the mixture comprises at least 0.5 wt %, 1 wt %, 5 wt %, 10 wt %, 15 wt %, 20 wt %, 25 wt %, 30 wt %, 40 wt %, 50 wt %, 60 wt %, or 70 wt % of the metal oxide.

Embodiment 25 is the method of any one of embodiments 1-24, wherein the solution or gel is acidic.

In any of embodiments 1-25, heating the mixture can include heating the mixture under selected conditions to a temperature no greater than a boiling point of the liquid under the same selected conditions. In one example, heating the mixture includes heating the mixture under a selected pressure in a range of about 0.1 bar to about 100 bar to a temperature no greater than a boiling point of the liquid under the selected pressure. In one example, heating the mixture includes heating the mixture under a selected pressure in a range of about 1 bar to about 3 bar to a temperature no greater than a boiling point of the liquid under the selected pressure.

Embodiment 26 is the solution or gel of any one of embodiments 1-25.

Embodiment 27 is solution or gel of embodiment 26, wherein the solution or gel is acidic.

Embodiment 28 is the solution or gel of embodiment 26 or 27, wherein the hydrogen-bonded molecular chains comprise:
one or more transition metal ions having a formal oxidation state of 4+, 5+, or 6; and
one or more oxo ligands, hydroxo ligands, aquo ligands, or any combination thereof,
wherein the polar organic solvent comprises methanol, ethanol, formamide, N-methyl formamide, N, N-dimethyl formamide, dimethyl sulfoxide, or any combination thereof.

Embodiment 29 is a composition comprising:
the acidic solution or gel of any one of embodiments 26-28; and
an additional material, wherein the additional material comprises an organic material, an inorganic material, a polymeric material, a biological material, a biogenic material, or any combination thereof,
wherein the additional material is soluble in the polar organic solvent.

Embodiment 30 is a material comprising:
the composition of embodiment 29; and
a medium comprising an aqueous medium, an organic medium, an inorganic medium, or a polymeric medium.

In any of embodiments 26-30, heating the mixture can include heating the mixture under selected conditions to a temperature no greater than a boiling point of the liquid under the same selected conditions. In one example, heating the mixture includes heating the mixture under a selected pressure in a range of about 0.1 bar to about 100 bar to a temperature no greater than a boiling point of the liquid under the selected pressure. In one example, heating the mixture includes heating the mixture under a selected pressure in a range of about 1 bar to about 3 bar to a temperature no greater than a boiling point of the liquid under the selected pressure.

Embodiment 31 is an acidic solution or gel comprising:
a hydrate of titanyl sulfate or a doped variant thereof;
sulfuric acid; and
a polar organic solvent.

Embodiment 32 is the acidic solution or gel of embodiment 31, wherein the polar organic solvent comprises methanol, ethanol, formamide, N-methyl formamide, N, N-dimethyl formamide, dimethyl sulfoxide, or any combination thereof.

Embodiment 33 is a composition comprising:
a metal oxide, wherein the metal oxide comprises hydrogen-bonded molecular chains, and each molecular chain comprises:
a metal from Groups 4-6;
at least one oxyanion of a main group element from Groups 15 and 16 bound to the metal through a polar covalent bond, wherein the at least one oxyanion is optionally protonated; and
at least one water molecule bound to the metal through a polar covalent bond; and
a polar organic solvent.

Advantages of methods described herein include ease of implementation and the diversity and uniqueness of precursors and solvents suitable for the preparation of metal-containing solutions or gels.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 shows powder X-ray diffraction (PXRD) patterns of a sample made from titanyl sulfate dihydrate (TiOSO₄·2H₂O, TSD) and water (TSD-H₂O-raw) and calcined precipitate (TSD-H₂O-450). A simulated pattern of anatase TiO₂ is also shown.

FIG. 2 shows PXRD patterns of TSD-methanol-aniline (TSD-MeOH-aniline) and TSD samples. A simulated pattern of TSD is also shown.

FIG. 3 shows PXRD patterns of TSD-dimethyl sulfoxide-aniline (TSD-DMSO-aniline) and TSD samples. A simulated pattern of TSD is also shown.

FIG. 4 shows PXRD patterns of TSD-DMSO-melamine and TSD samples. A simulated pattern of TSD is also shown

FIG. 5 shows PXRD patterns of TSD-N-methyl formamide (TSD-NMF) gel, lyophilized TSD-NMF gel and TSD samples.

FIGS. 6A-6C show PXRD patterns, nitrogen gas sorption isotherms, and pore size distributions, respectively, of TiO₂-fumed silica composites with different Ti:Si mole ratios.

FIG. 7 shows PXRD patterns of TiOSO₄-fumed silica composites with different Ti:Si mole ratios.

FIG. 8A shows PXRD pattern, FIG. 8B shows nitrogen gas sorption isotherms, and FIG. 8C shows pore size distribution of the prepared TiO₂.

FIG. 9 shows PXRD pattern of doped TiO₂. The asterisk (*) indicates the peak of silicon powder as an internal standard. Simulated pattern of anatase TiO₂ is also included.

FIGS. 10A-10C show PXRD patterns, attenuated total reflectance Fourier transform infrared (ATR-FTIR) spectra, and thermogravimetric analysis (TGA) curves, respectively, of the MoO₂(H₂O)(HPO₄) (PMol), PMol-formamide (PMol-FA) and PMol-NMF samples. A simulated PXRD pattern of PMol is also shown in FIG. 10A.

FIGS. 11A-11C show scanning electron micrographs of the PMol, PMol-FA, and PMol-NMF samples, respectively (scale bar=2 μm).

FIG. 12A shows PXRD patterns of PMol and PMol-FA-cetyl trimethyl ammonium bromide (PMol-FA-CTAB). FIG. 12B shows a scanning electron micrograph of PMol-FA-CTAB. FIG. 12C shows a transmission electron micrograph of PMol-FA-CTAB. A simulated PXRD pattern of PMol is also shown in FIG. 12A. The scale bar equals 10 μm in FIG. 17B and 2 μm in FIG. 12C.

FIG. 13A shows powder X-ray diffraction (PXRD) patterns, FIG. 13B shows gas sorption isotherms, and FIG. 13C shows pore distribution of products from TSD-MeOH and a NH₃/MeOH or NH₄OH solution.

FIG. 14 shows powder X-ray diffraction (PXRD) pattern of titanyl sulfate dihydrate in methanol (TSD-MeOH) reacted with a solution of polyacrylic acid in methanol (PAA-MeOH). A simulated pattern of titanium carbide is also included.

FIG. 15A shows a powder X-ray diffraction (PXRD) pattern, FIGS. 15B and 15C show scanning electron microscope (SEM) images, and FIGS. 15D and 15E show transmission electron microscope (TEM) images of the product Bassanite_TSD. A simulated PXRD pattern of bassanite (CaSO₄·0.5H₂O) is also included in FIG. 15A.

FIGS. 16A and 16B show scanning electron microscope (SEM) images at different magnification ratios of the titanium dioxide film on a silicon wafer. The scale bar equals 200 nm in FIG. 16A and 100 nm in 16B.

### DETAILED DESCRIPTION

A process is disclosed in which a solution or gel including nanostructures and/or sub-nanostructures is made by selecting a metal oxide and dissolving the metal oxide in a polar organic solvent. A suitable metal oxide for the process has a crystal structure that contains hydrogen-bonded molecular chains of the metal oxide. The molecular chains include a metal element from Groups 4-6, at least one oxyanion or protonated oxyanion of a main group element from Groups 15 and 16 that coordinates or binds the metal and at least one water molecule coordinating or bound to the metal through polar covalent bonds. Such a chemical composition provides labile protons that make the metal oxide a Brønsted solid acid. As used herein, a “polar covalent bond” generally refers to a covalent bond in which the bonding electrons are unevenly shared between the two bonded atoms, due to a difference in electronegativity. The chemical bonds between the transition metal atoms or ions and the oxygen atoms of the oxyanions, the protonated oxyanions and water molecules are polar covalent. Strong Brønsted metal oxides may be deprotonated in a polar organic solvent and consequently the deprotonated molecular chains of the metal oxide may dissolve in the solvent with a large dielectric constant and/or a large dipole moment. Such solvents may include short chain alcohols, amines and amides.

The solution or gel including the metal oxide and polar organic solvent can be further mixed with a liquid miscible with the organic solvent or a solid soluble in the organic solvent to yield another solution or gel. In some cases, the liquid is a sulfuric acid with a water amount of no greater than about 2 wt %, 7 wt %, 20 wt %, 22 wt %, 30 wt %, or 38 wt %. In some cases, the liquid is a concentrated sulfuric acid. The new solution or gel has a chemical composition different from the initial solution or gel.

The solutions or gels can be further treated in such a way that the organic solvent is removed to some extent by evaporation to yield a liquid material, semi-liquid material, semi-solid material, solid material, coating material, thin film material, monolith material, or powder material. As used herein, “coating” generally refers to a layer of a substance spread over a surface, and “thin film” generally refers to a layer of material having a thickness ranging from that of a single atom (e.g., a monolayer) to several micrometers.

In some cases, the solutions or gels can be further treated in such a way that addition of a chemical to the solutions or gels induces formation of solid particles in the solutions or gels. Collecting the particles may yield a powder material. In some cases, the chemical can be ammonia gas or ammonia in a solvent. In some cases, the chemical can be phosphoric acid or an organic acid as a solid or in a solvent. In some cases, the chemical can be an ionic compound as a solid or in a solvent.

In some cases, the liquid material, semi-liquid material, semi-solid material, solid material, coating material, thin film material, monolith material, or the powder material may be further treated to modify its chemical structure or the chemical structure of at least one of its components. Treating the liquid material, semi-liquid material, semi-solid material, solid material, coating material, thin film material, monolith material, or the powder material may include heating the liquid material, semi-liquid material, semi-solid material, solid material, coating material, thin film material, monolith material, or the powder material at a temperature above 50° C., 60° C., 70° C., 80° C., 90° C., 100° C., 200° C., 300° C., 400° C., 500° C., 600° C., 700° C., 800° C., 900° C., 1000° C., 1100° C., 1200° C., 1300° C., 1400, 1500° C. in the presence of air, oxygen gas, hydrogen gas, nitrogen gas, argon gas, or a combination thereof. In some cases, treating the liquid material, semi-liquid material, semi-solid material, solid material, coating material, thin film material, monolith material, or the powder material may include contacting liquid material, semi-liquid material, semi-solid material, solid material, coating material, thin film material, monolith material, or the powder material with a chemical. In some cases, contacting the liquid material, semi-liquid material, semi-solid material, solid material, coating material, thin film material, monolith material, or the powder material with a chemical may reduce the pH of the liquid material, semi-liquid material, semi-solid material, solid material, coating material, thin film material, monolith material, or the powder material. In some cases, contacting liquid material, semi-liquid material, semi-solid material, solid material, coating material, thin film material, monolith material, or the powder material with a chemical may remove at least one of the chemical components in the liquid material, semi-liquid material, semi-solid material, solid material, coating material, thin film material, monolith material, or the powder material. In some cases, contacting liquid material, semi-liquid material, semi-solid material, solid material, coating material, thin film material, monolith material, or the powder material with a chemical may increase the crystallinity of the liquid material, semi-liquid material, semi-solid material, solid material, coating material, thin film material, monolith material, or the powder material. Treating the liquid material, semi-liquid material, semi-solid material, solid material, coating material, thin film material, monolith material, or the powder material may yield titanium dioxide (TiO₂) in anatase, TiO₂-B, brookite or rutile form or a mixture thereof.

Evaporation of the solvent from the solution can further concentrate the solution or transform the solution to a gel. Further evaporation of the solvent from the gel can lead to a dry gel.

Herein a nanostructure is defined as a three-dimensional structure whose external or internal dimension is in a range of about 1 nm to about 100 nm at least along one direction. A sub-nanostructure is defined as a three-dimensional structure whose external or internal dimension is in a range of about 0.1 nm to about 1 nm along one or two directions. Examples of sub-nanostructures include molecular chains and monolayers. Molecular chains are one-dimensional in chemical bonding, while monolayers are two-dimensional. In some cases, the nanostructures and/or sub-nanostructures include molecular chains, molecular wires, nanowires, nanorods, nanoparticles, or any combination thereof.

In some cases, the metal oxide has a chemical structure that includes electrostatically neutral molecular chains. Herein a molecular chain in a chemical structure of a metal oxide is defined as a structural building block that is extended along one direction via metal-oxygen chemical bonding. The metal oxide molecular chains can be alternatively defined as an inorganic polymer without cross-linking. In a metal oxide, all or most of the constituent metal ions are surrounded by oxo ligands (O²⁻), hydroxo ligands (HO⁻), and/or aquo (H₂O) ligands. In some cases, the metal oxides can be Brønsted solid acids in which protons of the hydroxo ligands or aquo ligands in their crystal structure are labile.

In some cases, the electrostatically neutral molecular chains of the metal oxides are held together via hydrogen bonding in the chemical structure. The molecular chains may contain hydroxo ligands and/or aquo ligands in addition to oxo ligands, and at least some of the hydroxo ligands and/or aquo ligands are exposed to neighboring molecular chains to form the hydrogen bonding. Examples of such metal oxides include MoO₂(HPO₄)·H₂O and TiOSO₄·2H₂O.

Some of the metal oxides may contain transition metal ions that have an oxidation state of 4+, 5+ or 6+. In some of the metal oxides, a majority of the transition metal ions have an oxidation state of 4+, 5+ or 6+. Some of those metal oxides may contain a dopant whose oxidation state ranges from 1+ to 6+.

Some of the molecular chains in the metal oxides may contain oxyanions and/or their protonated forms as an additional building block of the molecular chains. Examples of oxyanions and their protonated forms include phosphate (PO₄³⁻), biphosphate (HPO₄²⁻), sulfate (SO₄²⁻) and bisulfate (HSO₄⁻).

In some cases, the empirical formula of the chosen metal oxides may be given as HₓM_{y}X_{z}O_{w} wherein M is a metal element chosen from Groups 4-6 or a doped variant thereof and X is a main group element chosen from Groups 15 and 16 or a doped variant thereof. In some cases, x/y ranges from 0.5 to 6, and y/z ranges from 0.5 to 3. Examples of such metal oxides include MoO₂(HPO₄)·H₂O and TiOSO₄·2H₂O. As used herein, a “doped variant” of HₓM_{y}X_{z}O_{w} generally refers to a compound that has less than 50 mol % of M metals in its crystal structure replaced by another metal. In some cases, the oxyanions, conjugate acids of the oxyanions, or both may be present in unbound form in the solutions or gels, because of chemical modification of the metal oxides during their dissolution.

When an aquo ligand or hydroxo ligand coordinates or binds a metal ion with a high oxidation state (4+, 5+ and 6+) through a polar covalent bond, the ligand can be acidic and easily deprotonated. The acidity may increase due to the inductive effect when an oxyanion or a protonated oxyanion coordinates or binds the same metal ion through a polar covalent bond.

In some cases, the chemical structures of the metal oxides may contain crystal water. The crystal water molecules are uncoordinated or unbound water molecules, and they may participate in hydrogen bonding in the chemical structures. In some cases, the metal oxide is substantially free of uncoordinated or unbound water molecules.

In some cases, the solution or gel may be made by heating the mixture of the metal oxide and a polar organic solvent. In some cases, the nominal concentration of the metal oxide may be over 0.5 wt %, 1 wt %, 5 wt %, 10 wt %, 20 wt %, 30 wt %, 40 wt %, 50 wt %, 60 wt %, or 70 wt %. In some cases, the heating temperature may be from 30° C. to a temperature not higher than the boiling point of the solvent under the internal pressure of the container. In some cases, the heating may be carried out under an autogenic pressure in a closed container. In some cases, the heating temperature may be from 30° C. to a temperature not higher than the boiling point of the solvent under a pressure higher than 1 atm. In some cases, the heating time may be up to a few hours, one day or 7 days. In some cases, the heating can be thermal. In some cases, the heating can be carried out by using microwave radiation. In some cases, the mixture of the metal oxide and the polar organic solvent is stirred, shaken or agitated. In some cases, the heating can be carried out in an open container under a reflux condition. In some cases, the heating can be carried out in a closed container. In some cases, the heating can be carried out in a closed container under a solvothermal condition.

In some cases, dissolving the metal oxide in a polar organic solvent modifies the chemical structure of the metal oxide. In some cases, the modified chemical structure is charged by deprotonation or protonation.

In some cases, the prepared solution or gel is more viscous than the solvent used for their preparation. In some cases, the viscosity of the solution or the gel is at least 2, 5, 10, 50, 100, 500, 1000, 5000, or 10000 times higher than that of the solvent at room temperature.

In some cases, the prepared solution or gel can be further treated to remove at least some of the solvent. In some cases, the solvent evaporation from the solution or the gel may increase the viscosity of the solution or the gel. In some cases, the solvent evaporation from the solution may convert the solution to a wet gel or a dry gel. In some cases, the solvent evaporation from the gel may convert a wet gel to a dry gel.

In some cases, the wet gel or the dry gel may be amorphous or partially amorphous based on their X-ray diffraction patterns. In some cases, the wet gel or the dry gel may be in the form of monoliths, particulates, powder, coatings, beads or films. In some cases, the solvent evaporation from the solution or the gel may yield a powder. In some cases, the wet gel, the dry gel, or the powder contain the solvent molecules that are protonated. In some cases, the wet gel, the dry gel, or the powder is soluble in water or a polar organic solvent.

In some cases, the solution or the gel can be further treated to induce precipitation. In some cases, the precipitation may be induced by adding a chemical agent that reduces the acidity of the solution or the gel. In some cases, the precipitation may be induced by adding a salt soluble in the solvent. In some cases, the precipitation may be induced by adding a solvent that is less polar than the polar organic solvent.

In some cases, the solvent comprises an organic solvent that has a dielectric constant of at least 25, 30, 35, 40, 45, 50, 55, 60, 70, 80, 90, or 100. In some cases, the solvent includes an organic solvent that has a dipole moment of at least 1.5 D, 2 D, 2.5 D, 3 D, 3.5 D, 4 D, or 5 D. In some cases, the organic solvent includes methanol, ethanol, formamide, N-methyl formamide, N, N-dimethyl formamide, dimethyl sulfoxide, or any combination thereof. In some cases, the solvent contains water as an impurity. For example, the methanol of the ACS reagent grade contains no greater than 0.2 wt % of water, while the ethanol of the ACS reagent grade contains no greater than 0.5 wt % of water. In some cases, the amount of water in the organic solvents can be no greater than 0.5 wt %, 1 wt %, 5 wt % or 10 wt %.

In some cases, the nanostructures and/or sub-nanostructures in the solution or the gel are co-present with organic materials, inorganic materials, nanomaterials, polymeric materials, biological materials, or biogenic materials that are soluble in the solvent. In some cases, the nanostructures and/or sub-nanostructures in the solution or the gel are in contact with organic materials, inorganic materials, nanomaterials, polymeric materials, biological materials, or biogenic materials. In some cases, the nanostructures and/or sub-nanostructures are bonded electrostatically or covalently with organic molecules, inorganic molecules, nanomaterials, polymers, biological materials, or biogenic materials. In some cases, the material is an inorganic material, inorganic-organic hybrid material, inorganic-inorganic hybrid material, inorganic-biogenic hybrid material, inorganic-biological hybrid material, or a combination thereof. As used herein, “hybrid material” generally refers to a composite having more than a single chemical constituent (e.g., discrete chemical compound) at the nanometer or molecular level.

### Examples

### Example 1

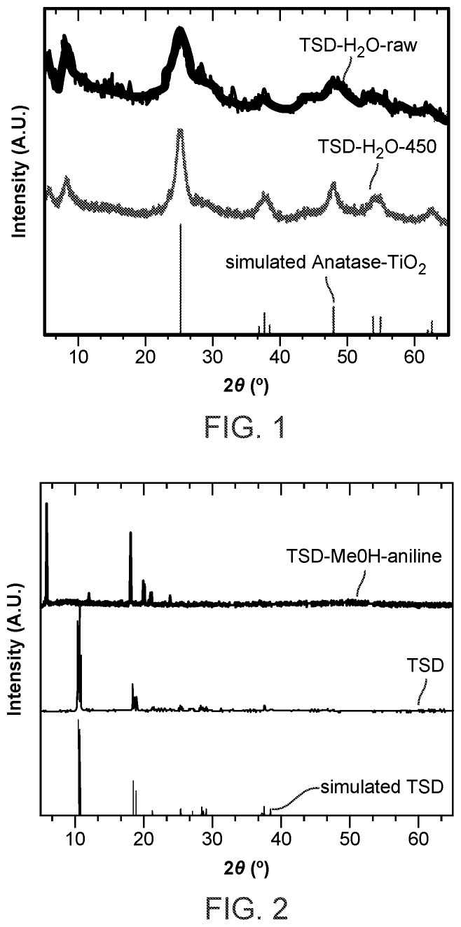

Solutions of titanyl sulfate dihydrate (TiOSO₄·2H₂O, “TSD”) were prepared with dimethyl sulfoxide (DMSO), N-methyl formamide (NMF), methanol (MeOH), ethanol (EtOH), and water as a solvent. Water is not an organic solvent and is used here for comparison purposes. 0.4248 g of TSD powder was added to 6 mL of DMSO and was heated in a closed vial at 90° C. in a lab oven for about 4 days. The resulting solution (“TSD-DMSO”) with a concentration of 6.1 wt % TSD was transparent and colorless. 0.0915 g of TSD powder was added to 1 mL of NMF and was heated in a closed vial at 90° C. in a lab oven for about 4 days. The resulting solution (“TSD-NMF”) with a concentration of 8.3 wt % TSD was transparent and slightly yellow in color. A solution of TSD in MeOH (“TSD-MeOH”) was prepared by adding 1.177 g of TSD to 1.5 mL of MeOH (Sigma-Aldrich, ACS reagent, ≥99.8%) and heating in a closed vial at 60° C. in a lab oven for about 4 days. The resulting TSD-MeOH solution with a concentration of 49.8 wt % TSD was transparent and highly viscous. A solution of TSD in EtOH (“TSD-EtOH”) was prepared by adding 0.48 g of TSD to 3 mL of EtOH (Sigma-Aldrich, ACS reagent, ≥99.5%) and heating in a closed vial at 75° C. in a lab oven for about 2 days. The resulting TSD-EtOH solution with a concentration of 17 wt % TSD was transparent and viscous. For an aqueous solution, 0.048 g of TSD was added to 3 mL of deionized water in a closed vial, and the mixture was stirred at 600 rpm for one hour. The resulting solution (TSD-H₂O) with a concentration of 1.6 wt % TSD was transparent and colorless. In contrast to the other solutions, a white precipitate appeared in the TSD-H₂O after one day. The precipitate was collected via centrifugation and further calcined at 450° C. in a muffle furnace for one hour. In FIG. 1, the powder X-ray diffraction (PXRD) patterns of both the as-collected precipitate (“TSD-H₂O-raw”) and the calcined precipitate (“TSD-H₂O-450”) showed broad Bragg peaks that are assigned to anatase TiO₂. A simulated pattern of anatase TiO₂ is also shown.

### Example 2

2.372 g of titanyl sulfate dihydrate (TiOSO₄-2H₂O, “TSD”) was added to 15.00 mL of methanol (MeOH) (Sigma-Aldrich, ACS reagent, ≥99.8%) and heated in a closed plastic tube at 60° C. in a lab oven for about 4 days. The resulting solution (“TSD-MeOH”) with a concentration of 19.6 wt % TSD was mainly clear and slightly yellow in color. 2.21 mL of aniline (C₆H₅NH₂), a primary amine, was added directly to the solution and the mixture was shaken. White particles started to appear after 15 minutes and they precipitated out after 30 minutes. The precipitate was collected via centrifugation and washed three times with 20 mL aliquots of ethanol. The resulting product was dried in air overnight and obtained as a white powder. The PXRD pattern of the product did not match that of TSD, indicating that the powder product was different from TSD. The PXRD patterns of the product, indicated as TSD-MeOH-aniline, and TSD are shown in FIG. 2.

### Example 3

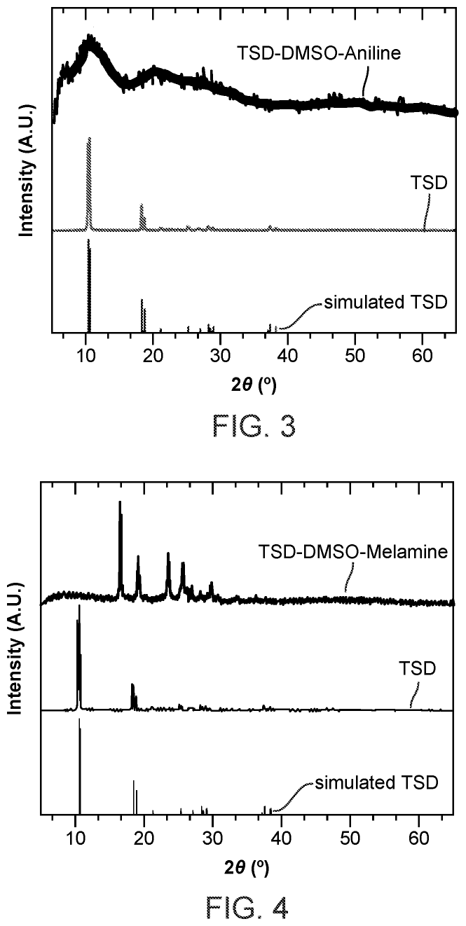

0.051 g of titanyl sulfate dihydrate (TiOSO₄·2H₂O, “TSD”) was added to 1.00 mL of dimethyl sulfoxide (DMSO) and was heated in a closed vial at 90° C. in a lab oven for about 4 days. The resulting solution (“TSD-DMSO”) with a concentration of 4.4 wt % TSD was mainly clear and slightly yellow in color. 0.025 mL of aniline (C₆H₅NH₂), a primary amine, was added directly to 0.5 mL of the solution and white precipitates formed immediately. The precipitate was collected via centrifugation and washed three times with 2.00 mL aliquots of ethanol. The resulting product was dried in air overnight and obtained as a light-yellow powder. The PXRD pattern of the product did not match with that of TSD, indicating that the powder product was different from TSD. The PXRD patterns of the product, indicated as TSD-DMSO-aniline, and TSD are shown in FIG. 3.

### Example 4

0.128 g of titanyl sulfate dihydrate (TiOSO₄·2H₂O, “TSD”) was added to 1.00 mL of dimethyl sulfoxide (DMSO) and heated in a closed vial at 90° C. in a lab oven for about 4 days. The resulting solution (“TSD-DMSO”) with a concentration of 10.4 wt % TSD was mainly clear and slightly yellow in color. 0.0824 g of melamine powder (C₃N₃(NH₂)₃), a primary amine, was added directly to 0.5 mL of the solution and white precipitates formed immediately. The precipitate was collected via centrifugation and washed three times with 2.00 mL aliquots of ethanol. The resulting product was dried in air overnight and obtained as a white powder. The PXRD pattern of the product did not match with that of TSD, indicating that the powder product was different from TSD. The PXRD patterns of the product, indicated as TSD-DMSO-melamine and TSD are shown in FIG. 4.

### Example 5

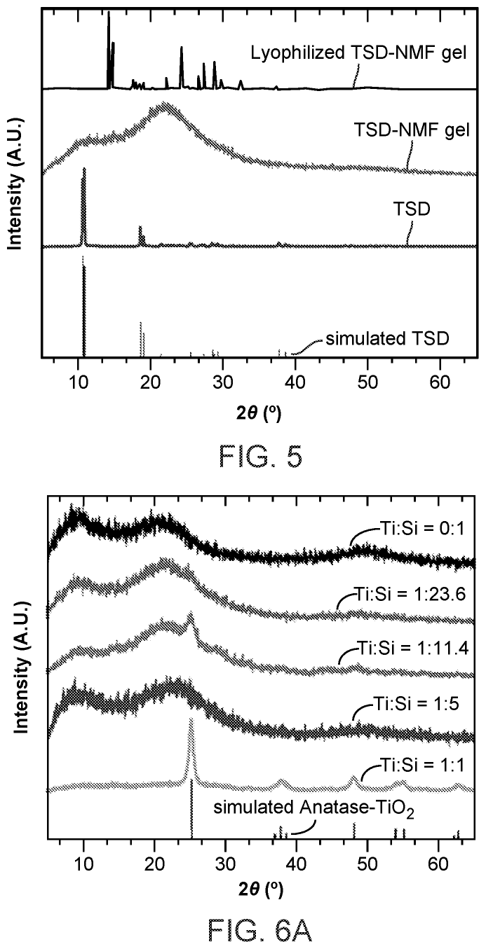

Solutions of titanyl sulfate dihydrate (TiOSO₄·2H₂O, “TSD”) in N-methyl formamide (NMF) were obtained by adding 58.7, 63.9, 68.5, 73.4, and 83.0 mg of the powder in 1 mL of the solvent in separate glass vials and subsequently heating them with tightly closed vial caps at 90° C. in a lab oven for about 4 days. The concentrations were 5.5, 5.9, 6.3, 6.8, and 7.6 wt % TSD, respectively. After heating, the resulting solutions turned to a soft gel which was clear and slightly yellow in color. The PXRD pattern of the wet gel showed a broad hump around 2θ=23°, indicating that the gel did not contain titanyl sulfate dihydrate in its crystalline form. 3 mL of acetonitrile (CH₃CN) was slowly added to the gel with a 5.9 wt % concentration for solvent exchange. Acetonitrile was changed daily for 4 days. Then, the solvent-exchanged gel was placed in a free-dryer and was lyophilized to remove the solvent for 4 days. The PXRD of the resulting lyophilized gel showed sharp Bragg reflection peaks that did not match that of TSD. The PXRD patterns of the TSD-NMF gels are shown in FIG. 5.

### Example 6

0.02 g of titanyl sulfate dihydrate (TiOSO₄·2H₂O, “TSD”) was added to 1 mL of dimethyl sulfoxide (DMSO) and heated in a closed vial at 90° C. in a lab oven for about 4 days. The resulting solution (“TSD-DMSO”) with a concentration of 1.8 wt % TSD was mainly clear and slightly yellow in color. 0.0447 g of poly(vinyl alcohol) ([CH₂CH(OH)]ₙ, “PVA”) was added to 1 mL of DMSO and was heated in a closed vial at 90° C. in a lab oven for 30 minutes. The resulting PVA solution (“PVA-DMSO”) with a concentration of 3.9 wt % PVA was clear and colorless. After cooling down, 0.223 mL of the TSD-DMSO solution was added directly to 0.1 mL of the PVA-DMSO solution, which resulted in immediate formation of a colorless, transparent gel.

### Example 7

0.1039 g of titanyl sulfate dihydrate (TiOSO₄·2H₂O, “TSD”) was added to 2 mL of methanol (MeOH) (Sigma-Aldrich, ACS reagent, ≥99.8%) and was heated in a closed vial at 60° C. in a lab oven for about 4 days. The resulting solution (“TSD-MeOH”) with a concentration of 6.2 wt % TSD was mainly clear and slightly yellow in color. 0.0407 g of poly(acrylic acid) ([CH₂CH(OH)]ₙ, “PAA”) was added to 1 mL of MeOH and was left at room temperature overnight. The resulting PAA solution (“PAA-MeOH”) with a concentration of 4.9 wt % PAA was clear and colorless. After cooling down, 0.078 mL of the TSD-MeOH solution was added directly to 0.1 mL of the PAA-MeOH solution, which resulted in immediate formation of a colorless, transparent gel.

### Example 8

0.2046 g of titanyl sulfate dihydrate (TiOSO₄·2H₂O, “TSD”) was added to 5.00 mL of methanol (MeOH) (Sigma-Aldrich, ACS reagent, ≥99.8%) and heated in a closed vial at 60° C. in a lab oven for about 4 days. The resulting solution (“TSD-MeOH”) with a concentration of 4.9 wt % TSD was mainly clear and slightly yellow in color. 0.047 g of poly(ethylene glycol) (H(C₂H₄O)ₙOH, “PEG”) was added to 1 mL of MeOH and heated in a closed vial at 60° C. in a lab oven for about 30 min. The resulting PEG solution (“PEG-MeOH”) with a concentration of 5.6 wt % PEG was clear and colorless. After cooling down, the solutions were mixed at three different TSD:PEG w/w ratios (1:10, 1:1 and 2:1). The resulting solutions were clear and colorless. Small aliquots of the solutions were dropped on a microscope glass slide and they formed thin and homogeneous coatings upon evaporation of MeOH. The transparency of the coatings was higher with an increased amount of TSD in the solutions.

### Example 9

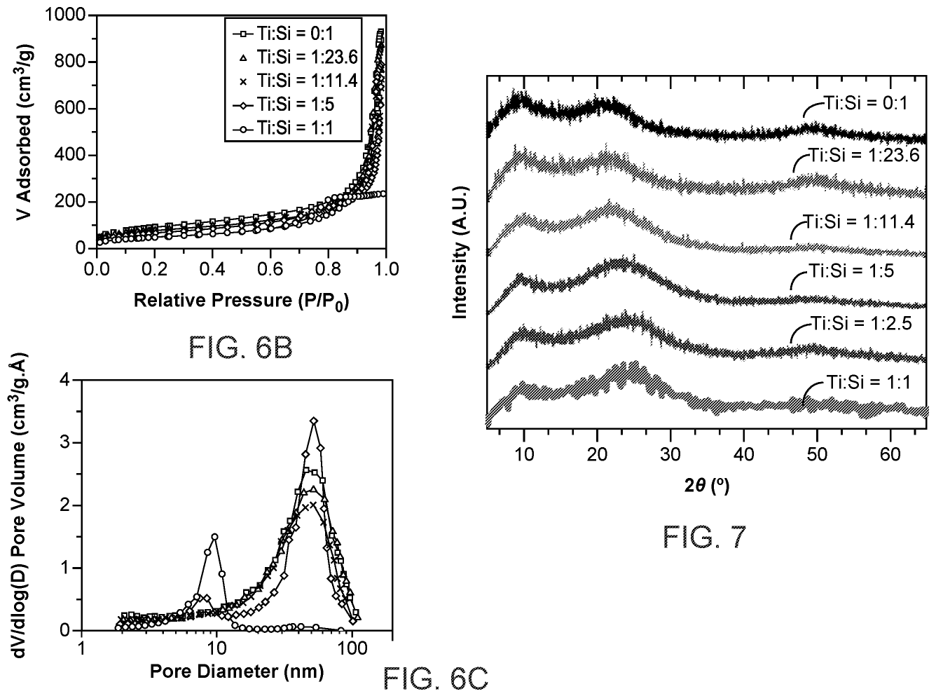

TiO₂-fumed silica composites were prepared with titanyl sulfate dihydrate in methanol (“TSD-MeOH”) solution and fumed silica (“FS”) as the following. The TSD-MeOH was first prepared by adding 9.486 g of titanyl sulfate dihydrate (TiOSO₄·2H₂O, “TSD”) to 60 mL of MeOH (Sigma-Aldrich, ACS reagent, ≥99.8%) and subsequently heating in a closed plastic tube at 60° C. in a lab oven for about 4 days. The concentration was 16.7 wt % TSD. The TiO₂-FS composites with different mole ratios of Ti:Si were prepared by adding the TSD-MeOH solution to FS in different amounts. In a typical procedure, FS powder was added to a TSD-MeOH solution in chosen amounts to form a slurry. The slurry mixture of TSD-MeOH and FS was grounded in a mortar until it became a dry white powder. The resulting powder was heated in a ceramic crucible at 90° C. in a lab oven for 2 hrs and then calcined at 600° C. for 2 hrs in a muffle furnace. The PRXD of the calcined powder samples were amorphous for all the samples, except for the sample with 1:1 mole ratio which showed anatase TiO₂ as the only crystalline phase in the product. The Brunauer-Emmett-Teller (BET) surface areas of the composites were estimated and listed in Table 1. The PXRD patterns, the nitrogen gas sorption isotherms, and pore size distributions of the samples are shown in FIGS. 6A-6C, respectively. The pore size distributions indicate that the products are porous with a significant amount of mesopores (2-50 nm).

TABLE 1
The BET surface area of the TiO₂—FS composites
prepared with nominal mole ratios of Ti:Si.

| Nominal Ti/Si | BET surface |
|---|---|
| mole ratio | area (m²/g) |
| 0:1 | 342 |
| 1:23.6 | 290 |
| 1:11.4 | 279 |
| 1:5 | 250 |

### Example 10

TiOSO₄-fumed silica composites were prepared with titanyl sulfate dihydrate in methanol (“TSD-MeOH”) solution and fumed silica (“FS”) as the following. The TSD-MeOH was first prepared by adding 9.486 g of titanyl sulfate dihydrate (TiOSO₄·2H₂O, “TSD”) to 60 mL of MeOH (Sigma-Aldrich, ACS reagent, ≥99.8%) and subsequently heating in a closed plastic tube at 60° C. in a lab oven for about 4 days. The concentration was 16.7 wt % TSD. The TiOSO₄-FS composites with different mole ratio of Ti:Si were prepared by adding the TSD-MeOH solution to FS in different amounts. In a typical procedure, FS powder was added to a TSD-MeOH solution in chosen amounts to form a slurry. The slurry mixture of TSD-MeOH and FS was ground in a mortar until it became a dry white powder. The resulting powder was heated in a ceramic crucible at 90° C. in a lab oven for 2 hrs and then calcined at 300° C. for 24 hrs in an ashing furnace. The PRXD of the calcined powder samples were amorphous for all the samples. The Brunauer-Emmett-Teller (BET) surface areas of the composites were estimated and listed in Table 2. The PXRD patterns of the samples are shown in FIG. 7.

TABLE 2
The BET surface area of the TiOSO₄—FS composites
prepared with nominal mole ratios of Ti:Si.

| Nominal Ti/Si | BET surface |
|---|---|
| mole ratio | area (m²/g) |
| 0:1 | 338 |
| 1:23.6 | 215 |
| 1:11.4 | 177 |
| 1:5 | 134 |
| 1:2.5 | 48 |
| 1:1 | 28 |

### Example 11

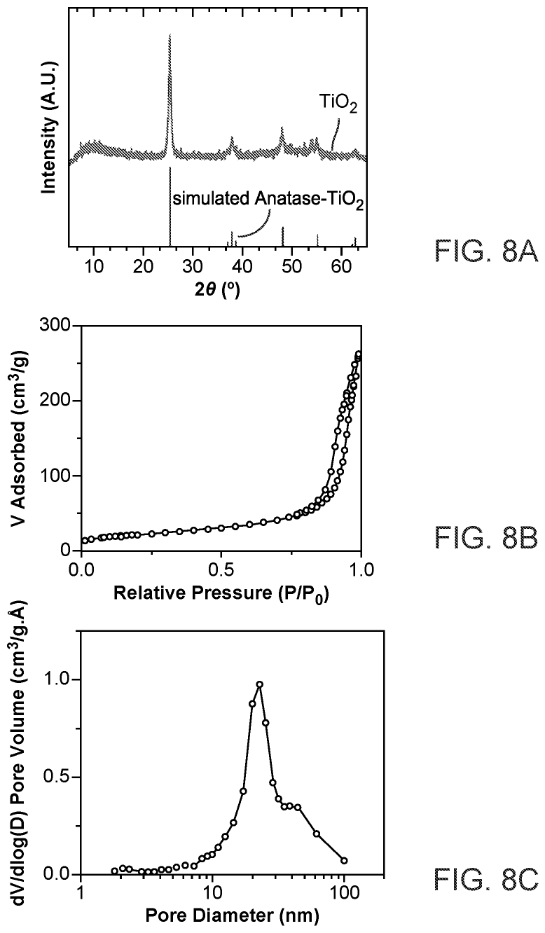

Free-standing thin films of anatase TiO₂ were produced by coating micron-sized NaCl powder particles as a sacrificial template as the following. A titanyl sulfate dihydrate in methanol (“TSD-MeOH”) solution was prepared by adding 1.581 g of titanyl sulfate dihydrate (TiOSO₄·2H₂O, “TSD”) to 10 mL of MeOH (Sigma-Aldrich, ACS reagent, ≥99.8%) and subsequently heating in a closed plastic tube at 60° C. in a lab oven for about 4 days. The concentration was 16.7 wt % TSD. NaCl was preheated at 120° C. in a furnace for 3 hrs to dry. 1 mL of the TSD-MeOH solution was diluted with 50 mL of MeOH and then added to the dried NaCl powder. The mixture was stirred continuously at room temperature until the mixture became dried. The mixture was placed in a 90° C. oven overnight for further removal of the solvent and then calcined at 600° C. for 3 hrs in a muffle furnace. The calcined sample was washed with a copious amount of deionized water to remove NaCl. The white powder was collected by centrifugation, rinsed with water and ethanol multiple times and finally dried in a 90° C. oven for 3 hrs. The PXRD pattern of the resulting powder showed the Bragg peaks that match anatase TiO₂. The BET surface area of the powder was estimated to be 79.33 m²/g. The PXRD pattern, the nitrogen gas sorption isotherms and pore size distribution of the prepared TiO₂ powder are shown in FIGS. 8A-8C, respectively. The pore size distribution indicates that the product is porous with a significant amount of mesopores (2-50 nm).

### Example 12

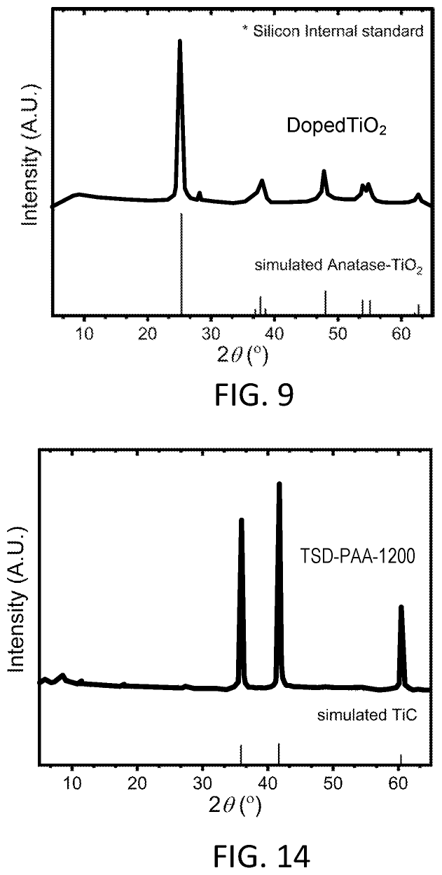

Molybdenum-doped TiO₂ was synthesized with a titanyl sulfate dihydrate in methanol (“TSD-MeOH”) solution and molybdic acid (MoO₃·H₂O). The TSD-MeOH solution was prepared by adding 1.581 g of titanyl sulfate dihydrate powder (TiOSO₄·2H₂O, “TSD”) to 10 mL of MeOH (Sigma-Aldrich, ACS reagent, ≥99.8%) and subsequently heating in a closed plastic tube at 60° C. in a lab oven for about 4 days. The concentration of the solution was 20 wt % TSD. A white powder of MoO₃·H₂O was added to the TSD-MeOH solution to give a mole ratio of Mo:Ti=1:10 and the mixture was heated in a closed plastic tube at 60° C. in a lab oven for 10 days. The resulting solution was deep blue in color with no solid residue. The solution was than air-dried to give a solid with a deep blue color. The solid was calcined at 600° C. for 8 hrs in a muffle furnace. The calcined product was a light grey homogeneous powder and had the PXRD pattern matching with that of anatase TiO₂ with a slight shift in peak positions and broadened Bragg peaks. The PXRD pattern of the doped TiO₂ powder is shown in FIG. 9. A simulated pattern of anatase TiO₂ is also included in FIG. 9.

### Example 13

Solutions of MoO₂(H₂O)(HPO₄) (“PMol”) in N-methyl formamide (NMF) were obtained by adding 53.0, 111.9, 156.4, and 220.1 mg of white PMol powder in 1 mL of NMF in separate glass vials and subsequently heating with tightly closed vial caps at 90° C. in a lab oven. The concentrations of the solutions (“PMol-NMF”) were 5.0, 10.0, 13.4 and 17.9 wt % PMol. After 3 hrs of heating, the solutions were pale blue except for the lowest concentration, with a white powder remaining at the bottom of the vials. After 6 hrs of heating, all the solutions became transparent, with no color or a light blue color and without any solid in the vials.

### Example 14

Solutions of MoO₂(H₂O)(HPO₄) (“PMol”) in N-methyl formamide (NNF) were obtained by mixing 0.5, 0.75, and 1.0 g of yellowish PMol powder with 1 mL of NMF in separate glass vials and subsequently heating with tightly closed vial caps at 90° C. in a lab oven. The concentrations of the solutions (“PMol-NMF”) were 33, 43, and 50 wt % PMol. After 2 days of heating, the 33.1 wt % sample became clear while the other showed a significant dissolution of PMol. After 4 days of heating, all the samples became clear with a blue color. After 5 days of heating, all the samples were clear with a dark blue color. All the samples were viscous and gel-like, exhibiting viscosity increases in PMol concentration.

### Example 15

A 49.7 wt % gel of MoO₂(H₂O)(HPO₄) (“PMol”) in N-methyl formamide (NMF) was obtained by adding 1.0 g of white PMol powder in 1 mL solvent in a glass vial and subsequently heating it with tightly closed vial caps at 90° C. in a lab oven for 3 days. After 3 days of heating, the gel became dark blue within the glass vial. When removed from the vial and spread on a substrate, the gel was transparent upon visual inspection.

### Example 16

Solutions of MoO₂(H₂O)(HPO₄) (“PMol”) in formamide (FA) were obtained by adding 66.3 and 107.3 mg of the white PMol powder in 1 mL solvent in separate glass vials and subsequently heating them with tightly closed vial caps at 90° C. in a lab oven for 6 hours. After heating, the resulting 5.5 and 8.7 wt % PMol solutions were colorless and slightly blue, respectively. Both were transparent. Continued heating of these samples at 90° C. in a lab oven for 6 hours for an additional 18 hours produced white precipitate with a cloudy blue supernatant. Solutions with concentrations below 4.2 wt % PMol could also be produced in a similar manner. These remained colorless and transparent solution regardless of heating time.

### Example 17

Solutions of MoO₂(H₂O)(HPO₄) (“PMol”) in methanol (MeOH) were obtained by adding 118, 225, and 303 mg of white PMol powder in 1 mL of MeOH (Sigma-Aldrich, ACS reagent, ≥99.8%) in separate glass vials and subsequently heating them with tightly closed vial caps at 60° C. in a lab oven. The concentrations were 13.0, 22.1, and 27.7 wt % PMol. After 4 hrs of heating, the solutions were dark blue. While the 13.0 wt % PMol sample showed complete dissolution, the higher concentration samples had a white powder remaining at the bottom of the vials. After 100 hrs of heating, the samples were clear and in dark blue without a solid residue.

### Example 18

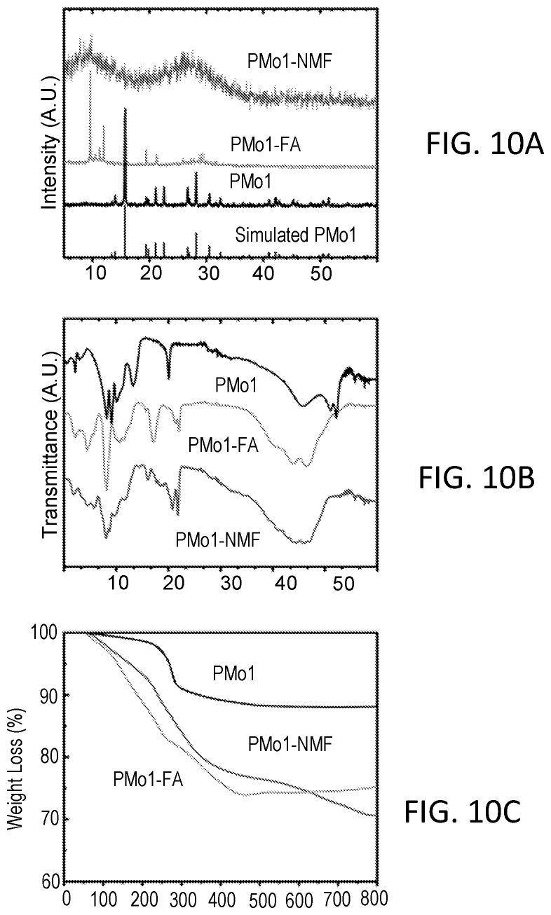

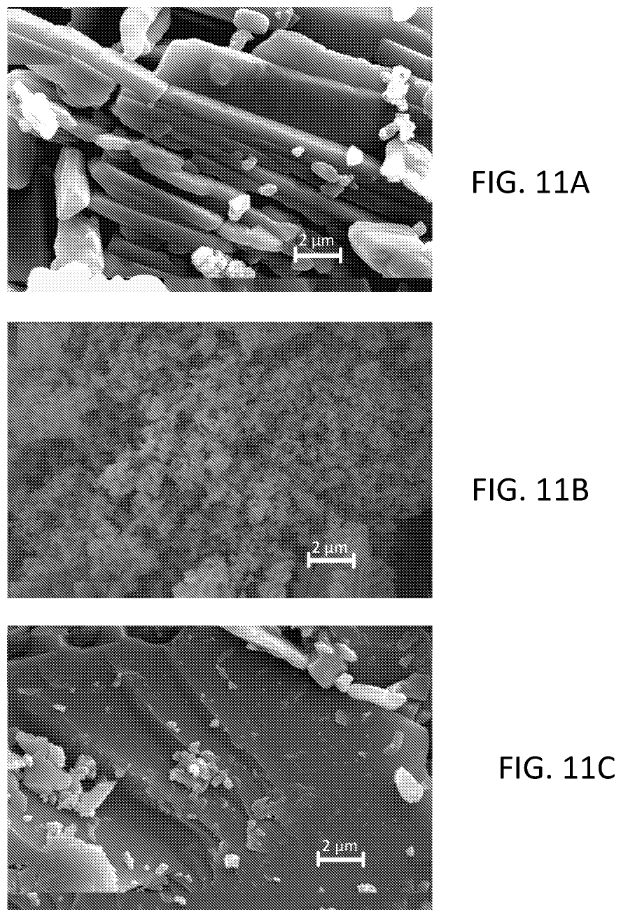

0.123 g of MoO₂(HPO₄)·H₂O (“PMol”) powder was added in 15 mL of FA or NMF and was heated at 90° C. in a lab oven for about 7 days. The resulting solutions were mainly clear and slightly blue in color. The solutions were centrifuged and the bluish supernatant was collected by decanting. 40 mL of a 3:1 (vol:vol) acetone:hexane mixture solvent was added to the solution and the solution turned cloudy, forming a precipitate. The precipitate was collected via centrifugation and washed with 20 mL of acetone three times. The resulting product with FA (“PMol-FA”) had a powder like consistency and was white in color with the one with NMF (“PMol-NMF”) had a blue color. The products were dried in air for a few days. The PXRD patterns of the dried powder products did not match with that of the PMol, indicating that the powder products were not PMol. ATR-FTIR and Raman spectra of the powder product showed the absorption peaks corresponding to the vibrational modes from FA and NMF, indicating presence of the molecules in the respective powder products. Elemental analysis indicated that molybdenum phosphorous and oxygen elements were present in both of the PMol-FA and PMol-NMF powder products at about 1:1:5 atomic ratios, while the presence of carbon element was not quantified due to the interference of the sample mount. The PXRD patterns, ATR-FTIR spectra and thermogravimetric analysis (TGA) curves of PMol, PMol-FA and PMol-NMF samples are shown in FIGS. 10A-10C, respectively. SEM images of PMol, PMol-FA, and PMol-NMF samples are shown in FIGS. 11A-11C, respectively.

### Example 19

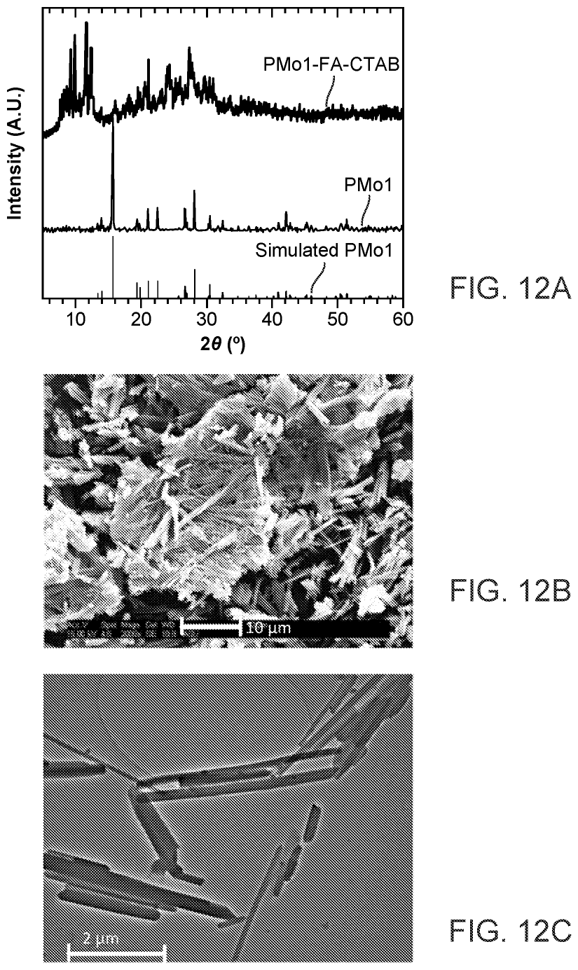

0.250 g of MoO₂(HPO₄)·H₂O (“PMol”) powder was added to 15 mL of FA and was heated at 90° C. in a lab oven for about 7 days. The resulting 1.5 wt % solution was mainly clear and slightly blue in color. The solutions were centrifuged and the bluish supernatant was collected by decanting. A solution containing 0.400 g of cetyl trimethyl ammonium bromide (CTAB) in 30 mL of FA was added directly to the PMol-FA solution and then excess amounts of acetone was added, which caused a white precipitate (“PMol-FA-CTAB”) to form immediately. The precipitate was collected via centrifugation and washed with 20 mL of acetone three times. The product was dried in air for a few days and the product remained white. The PXRD pattern of the powder product did not match with that of the PMol, indicating that the powder product was not PMol. ATR-FTIR spectra of the powder product showed the absorption peaks corresponding to the vibrational modes from FA and CTAB, indicating presence of the molecules in the respective powder products. SEM images revealed wire-like particles, and elemental analysis indicated that molybdenum, phosphorous, and oxygen elements were present in the PMol-FA-CTAB powder product at about 1:1:6 atomic ratios, while the presence of carbon element was not quantified due to the interference of the sample mount. The PXRD patterns of PMol and PMol-FA-CTAB are shown in FIG. 12A and an SEM image of PMol-FA-CTAB sample is shown in FIG. 12B. A TEM image of PMol-FA-CTAB is shown in FIG. 12C.

### Example 20

Viscous solutions, gels, semi-liquids, semi-solids and solids were produced with titanyl sulfate dihydrate in methanol (“TSD-MeOH”) solution and sulfuric acid (H₂SO₄). TSD-MeOH was first prepared by adding 6.324 g of titanyl sulfate dihydrate (TiOSO₄·2H₂O, “TSD”) to 40 mL of MeOH (Sigma-Aldrich, ACS reagent, ≥99.8%) and subsequently heating in an open round-bottomed flask under reflux for about 10 hours. The concentration was 20 wt. %. The solution was mixed with a concentrated sulfuric acid at the TSD:H₂SO₄ mole ratios of 1:1, 1:2 and 1:3 to form transparent, homogeneous mixtures. The mixtures were heated in glass vials at 60° C. in a lab oven for 2 hours to remove the methanol solvent. After cooling, the mixtures were in the form of transparent, homogeneous gels which were more viscous than the initial mixtures. The vials with the gels were further heated on a hot plate set at 150° C. for 12 hours. The resulting products were homogeneous and in the form of a semi-liquid, semi-solid or solid, depending on temperature and TSD:H₂SO₄ mole ratio. Semi-liquids showed a significant stickiness to the surfaces of various solids including metals, plastics, glass, natural fibers, rubber, and metal oxides.

### Example 21

Hybrid powder materials of titanyl sulfate dihydrate, sulfuric acid and fumed silica were prepared with titanyl sulfate dihydrate in methanol (“TSD-MeOH”) solution, a concentrated sulfuric acid (H₂SO₄) and a fumed silica (“FS”) powder by using incipient wetness impregnation method with the fumed silica as a porous support. TSD-MeOH was first prepared by adding 6.324 g of titanyl sulfate dihydrate (TiOSO₄·2H₂O, “TSD”) to 40 mL of MeOH (Sigma-Aldrich, ACS reagent, ≥99.8%) and subsequently heating in an open round-bottomed flask under reflux for about 10 hours. The concentration was 20 wt. % and the solution was stored in a closed plastic tube. To the TSD-MeOH solution, a concentrated sulfuric acid was added at different ratios to form homogeneous solutions. The solutions were then added dropwise to chosen amounts of FS powder to form slurry mixtures. The slurry mixtures of TSD-MeOH, H₂SO₄ and FS were dried and grounded in a mortar until they became a dry white powder. The resulting powders were heated in a ceramic crucible at 60° C. in a lab oven overnight and then heated at 150° C. for 2 hours in a muffle furnace. The final products were a light grey powder. The powder samples were amorphous based their X-ray diffraction patterns. The Brunauer-Emmett-Teller (BET) surface areas of the composites were estimated and listed in Table 3.

TABLE 3
The BET surface area of the samples prepared
with nominal mole ratios of TSD:H₂SO₄:FS.

| | Nominal TSD:H₂SO₄:FS | BET surface |
|---|---|---|
| Sample No. | mole ratios | area (m²/g) |
| 1 | 1:2:5 | 35.1 |
| 2 | 1:3:5 | — |
| 3 | 1:2:10 | 82.1 |
| 4 | 1:3:10 | 81.6 |
| 5 | 1:1:10 | 86.6 |

### Example 22

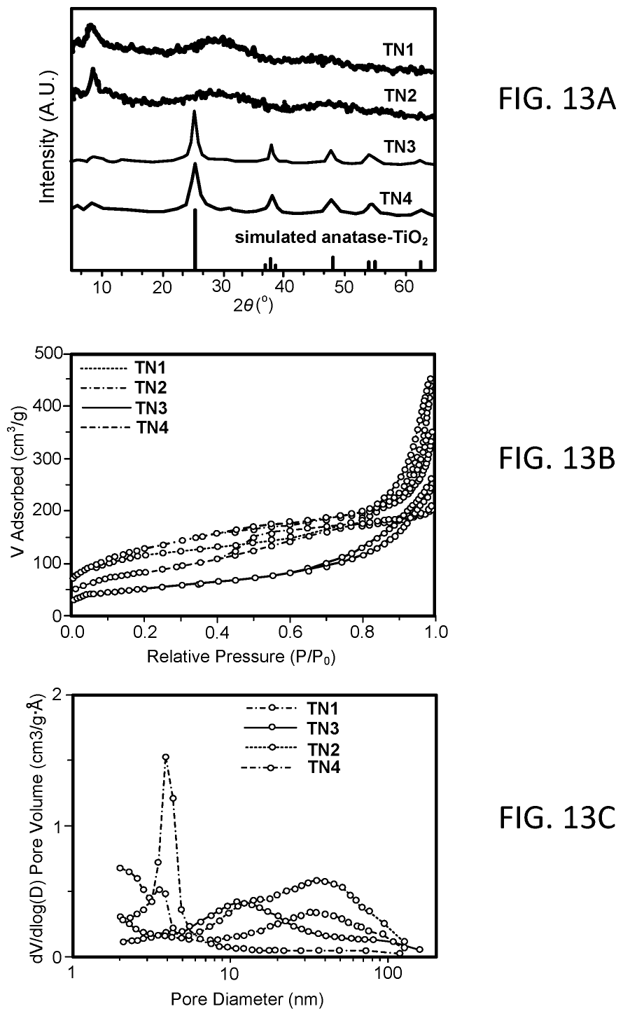

Amorphous titanium dioxide was prepared with a solution of titanyl sulfate dihydrate in methanol (“TSD-MeOH”) and a concentrated ammonium hydroxide solution (28-30 wt % NH₄OH). The TSD-MeOH solution was prepared by adding 1.581 g of titanyl sulfate dihydrate powder (TiOSO₄·2H₂O, “TSD”) to 10 mL of MeOH (Sigma-Aldrich, ACS reagent, ≥99.8%) and subsequently heating in an open round-bottomed flask under reflux for 10 hours. The concentration of the solution was 20 wt % TSD. 2.30 mL of the NH₄OH solution, was added dropwise to the TSD-MeOH solution with constant stirring, giving a molar ratio of TSD:NH₄OH=1:2. A white precipitate formed immediately. The precipitate was collected by centrifugation and washed with water, repeatedly until the supernatant did not contain an appreciable amount of sulfates. After decanting the supernatant, the precipitate was dried at 90° C. in a lab oven overnight. The PXRD of the dry, white powder, denoted as TN1, was amorphous. The Brunauer-Emmett-Teller (BET) surface area of the sample was estimated and listed in Table 4. The PXRD pattern, gas sorption isotherms and pore size distribution of the sample are shown in FIGS. 13A-13C, respectively. The pore size distribution indicates that the product is porous with a significant amount of mesopores (2-50 nm).

### Example 23

Amorphous titanium dioxide was prepared with a solution of titanyl sulfate dihydrate in methanol (“TSD-MeOH”) and a 7 N solution of ammonia in methanol (“NH₃/MeOH 7N”). The TSD-MeOH solution was prepared by adding 1.581 g of titanyl sulfate dihydrate powder (TiOSO₄·2H₂O, “TSD”) in 10 mL of MeOH (Sigma-Aldrich, ACS reagent, ≥99.8%) and subsequently heating in an open round-bottomed flask under reflux for 10 hours. The concentration of the solution was 20 wt % TSD. 2.30 mL of NH₃/MeOH 7N was added dropwise to the TSD-MeOH solution with constant stirring, giving a molar ratio of TSD:NH₃=1:2. A white precipitate formed immediately. The precipitate was collected by centrifugation and washed with water, repeatedly until the supernatant did not contain an appreciable amount of sulfates. After decanting the supernatant, the precipitate was dried at 90° C. in a lab oven overnight. The PXRD of the dry, white powder, denoted as TN2, was amorphous. The Brunauer-Emmett-Teller (BET) surface area of the sample was estimated and listed in Table 4. The PXRD pattern, gas sorption isotherms and pore size distribution of the sample were shown in FIGS. 13A-13C. The pore size distribution indicates that the product is porous with a significant amount of mesopores (2-50 nm).

TABLE 4
Surface areas, pore volumes and average pore
sizes of the products (TN1-TN4) from TSD-MeOH and a
NH₃/MeOH or NH₄OH solution.

| | TN1 | TN2 | TN3 | TN4 |
|---|---|---|---|---|
| BET surface | 405.0 | 462.8 | 184.1 | 304.3 |
| area (m²/g) | | | | |
| micropore | 141.1 | 31.6 | 23.4 | 12.0 |
| area (m²/g) | | | | |
| external surface | 263.9 | 431.2 | 160.7 | 292.3 |
| area (m²/g) | | | | |
| pore volume | 0.68 | 0.53 | 0.38 | 0.32 |
| (cm³/g) | | | | |
| average pore | 6.8 | 4.5 | 8.3 | 4.2 |
| width (nm) | | | | |

### Example 24

Anatase titanium dioxide (TiO₂) was prepared with a solution of titanyl sulfate dihydrate in methanol (“TSD-MeOH”) and an ammonium hydroxide solution (28-30 wt % NH₄OH). The TSD-MeOH solution was prepared by adding 1.581 g of titanyl sulfate dihydrate powder (TiOSO₄·2H₂O, “TSD”) to 10 mL of MeOH (Sigma-Aldrich, ACS reagent, ≥99.8%) and subsequently heating in an open round-bottomed flask under reflux for 10 hours. The concentration of the solution was 20 wt % TSD. 2.30 mL of the NH₄OH solution was added dropwise to the TSD-MeOH solution with constant stirring, giving a molar ratio of TSD:NH₄OH=1:2. A white precipitate formed immediately. The precipitate was collected by centrifugation and washed with 20 mL of ethanol three times, then dried at 90° C. in a lab oven overnight. The dried precipitate was collected by centrifugation and washed with water, repeatedly until the supernatant did not contain an appreciable amount of sulfates. After decanting the supernatant, the wet powder was dried at 90° C. in a lab oven overnight. The PXRD of the dry, white powder, denoted as TN3, showed the Bragg peaks that match anatase TiO₂. The Brunauer-Emmett-Teller (BET) surface area of the sample was estimated and listed in Table 4. The PXRD pattern, gas sorption isotherms and pore distribution of the sample were shown in FIGS. 13A-13C.

### Example 25

Anatase titanium dioxide was prepared with a solution of titanyl sulfate dihydrate in methanol (“TSD-MeOH”) and a 7 N solution of ammonia in methanol (“NH₃/MeOH 7N”). The TSD-MeOH solution was prepared by adding 1.581 g of titanyl sulfate dihydrate powder (TiOSO₄·2H₂O, “TSD”) in 10 mL of MeOH (Sigma-Aldrich, ACS reagent, ≥99.8%) and subsequently heating in an open round-bottomed flask under reflux for 10 hours. The concentration of the solution was 20 wt % TSD. 2.30 mL of NH₃/MeOH 7N was added dropwise to the TSD-MeOH solution with constant stirring, giving a molar ratio of TSD:NH₃=1:2. A white precipitate formed immediately. The precipitate was collected by centrifugation and washed with 20 mL of ethanol three times, then dried at 90° C. in a lab oven overnight. The dried precipitate was collected by centrifugation and washed with water, repeatedly until the supernatant did not contain an appreciable amount of sulfates. After decanting the supernatant, the wet powder was dried at 90° C. in a lab oven overnight. The PXRD of the dry, white powder, denoted as TN4, showed the Bragg peaks that match anatase TiO₂. The Brunauer-Emmett-Teller (BET) surface area of the sample was estimated and listed in Table 4. The PXRD pattern, gas sorption isotherms and pore size distribution of the sample were shown in FIGS. 13A-13C.

### Example 26

Titanium carbide (TiC) was prepared with a solution of titanyl sulfate dihydrate in methanol (“TSD-MeOH”) and a solution of polyacrylic acid in methanol (PAA-MeOH). The TSD-MeOH solution was prepared by adding 1.581 g of titanyl sulfate dihydrate powder (TiOSO₄·2H₂O, “TSD”) to 10 mL of MeOH (Sigma-Aldrich, ACS reagent, ≥99.8%) and subsequently heating in an open round-bottomed flask under reflux for 10 hours. The concentration of the solution was 20 wt % TSD. The PAA-MeOH solution was prepared by adding 590.1 mg of PAA powder to 10 mL of MeOH and subsequently sonicating for 30 minutes. The concentration of the PAA-MeOH solution was 59 g/L. 3.42 mL of the PAA-MeOH solution was added gradually to 1 mL of the TSD-MeOH solution with vigorous stirring, giving a weight ratio of TSD:PAA=1:1.11. The mixture turned into a transparent gel immediately after all the PAA-MeOH solution was added. The gel was dried at 60° C. in a lab oven overnight. The dry, transparent and colorless gel was heated under an Ar gas flow in a tube furnace first at 600° C. for 2 hours and then at 1200° C. for another 2 hours. The final product was black in color and retained the original shape of the dried gel pieces. The PXRD of the black product showed the Bragg peaks that match titanium carbide as shown in FIG. 14.

### Example 27

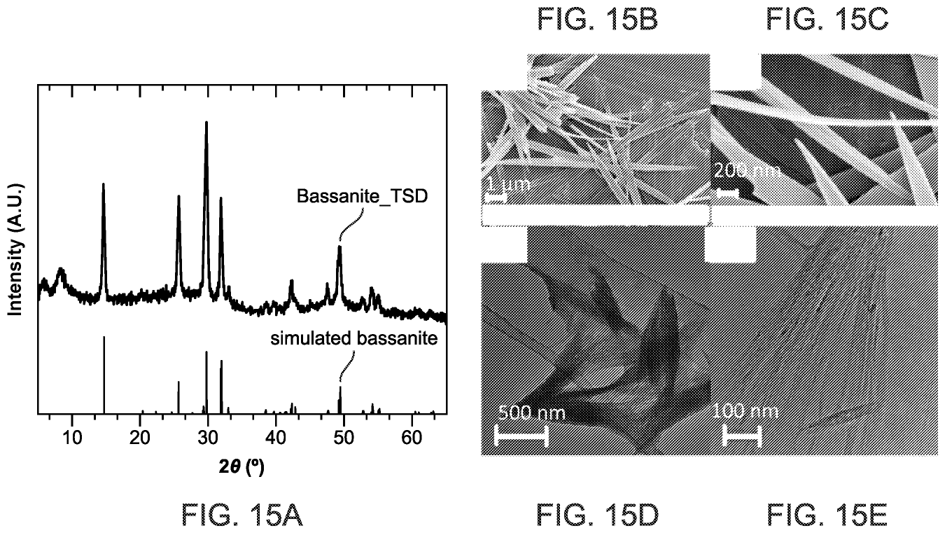

Bassanite-titanium dioxide hybrid material was synthesized from calcite (CaCO₃) and a solution of titanyl sulfate dihydrate in methanol (“TSD-MeOH”). The TSD-MeOH solution was prepared by adding 1.581 g of titanyl sulfate dihydrate powder (TiOSO₄·2H₂O, “TSD”) to 10 mL of MeOH (Sigma-Aldrich, ACS reagent, ≥99.8%) and subsequently heating in an open round-bottomed flask under reflux for 10 hours. The concentration of the solution was 20 wt % TSD. 5 mL of the TSD-MeOH solution was added gradually to 0.4037 g of calcite with constant stirring, giving a molar ratio of Ti:Ca=1:1. After 24 hours of continuous stirring, the precipitate was collected by centrifugation and washed with ethanol three times, then dried in air. The resulting powder was white. The PXRD of the product showed the Bragg peaks that match bassanite phase (calcium sulfate hemihydrate, CaSO₄·0.5 H₂O) as shown in FIG. 15A. Scanning electron microscope (SEM) images shown in FIGS. 15A and 15B and transmission electron microscope (TEM) images shown in FIGS. 15D and 15E of the product showed nanofibers with an estimated diameter of ˜20 nm and aspect ratios larger than 50.

### Example 28

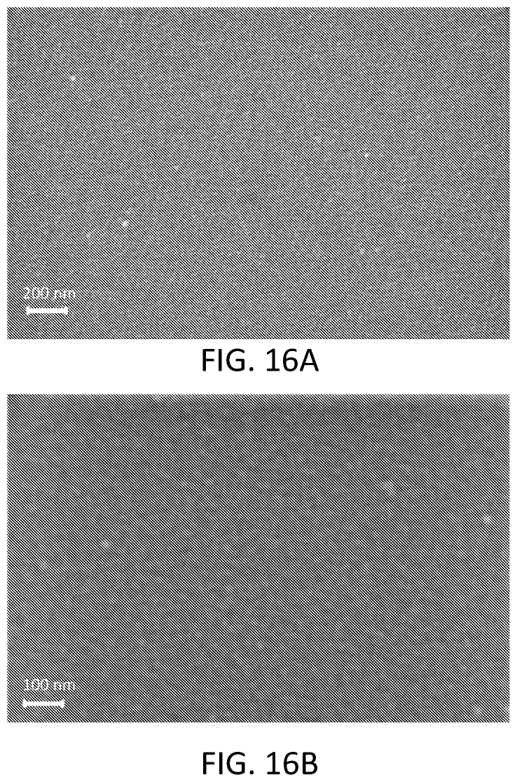

A thin titanium dioxide film on a silicon wafer was prepared from a solution of titanyl sulfate dihydrate in methanol (“TSD-MeOH”) and a solution of ammonia in methanol (NH₃/MeOH) solution. The TSD-MeOH solution was prepared by adding 100.0 mg of titanyl sulfate dihydrate powder (TiOSO₄·2H₂O, “TSD”) to 100 mL of MeOH (Sigma-Aldrich, ACS reagent, ≥99.8%) and subsequently heating in an open round-bottomed flask under reflux for 10 hours. The concentration of the solution was 1 mg/mL, corresponding to 0.13 wt % TSD. A ˜1×1 cm silicon wafer was cleaned with ethanol and left dried in air. 6.0 μL of the TSD-MeOH solution was dropped on the wafer and left dried in air. Subsequently, the silicon wafer was soaked in a 1 N solution of ammonia in methanol for 1 hour. After 1 hour, the silicon wafer was taken out of the solution and rinsed with ethanol. The silicon wafer was then soaked in deionized water for 1 hour. After soaking in water, the wafer was taken out and dried at 90° C. in a lab oven overnight. SEM images of the film provided in FIGS. 16A and 16B show that the TiO₂ film was flat and uniform. Little to no sulfur was detected in the film based on energy-dispersive X-ray spectroscopy (EDX), indicating the lack of sulfates in the film.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of preparing a metal-containing solution or gel, the method comprising:
combining a metal oxide and a liquid comprising a polar organic solvent to yield a mixture, wherein the metal oxide comprises hydrogen-bonded molecular chains, and each molecular chain comprises:
a metal from Groups 4-6;
at least one oxyanion of a main group element from Groups 15 and 16 bound to the metal through a polar covalent bond, wherein the at least one oxyanion is optionally protonated; and
at least one water molecule bound to the metal through a polar covalent bond; and
heating the mixture to yield a solution or gel comprising the polar organic solvent and the metal.

2. The method of claim 1, wherein the solution or gel is combined with an additional liquid miscible with the polar organic solvent or a solid soluble in the polar organic solvent to yield another solution or gel.

3. The method of claim 2, wherein the additional liquid comprises sulfuric acid.

4. The method of claim 1, further comprising removing the polar organic solvent from the solution or gel to yield a material in the form of a liquid, semi-liquid, semi-solid, solid, coating, thin film, monolith, or powder.

5. The method of claim 4, wherein the material comprises nanostructures, sub-nanostructures, or a combination thereof.

6. The method of claim 4, wherein the material is an inorganic material, inorganic-organic hybrid material, inorganic-inorganic hybrid material, inorganic-biogenic hybrid material, inorganic-biological hybrid material, or a combination thereof.

7. The method of claim 4, further comprising treating the material to modify a chemical structure, a chemical composition, or both of the material.

8. The method of claim 7, wherein treating the material comprises heating the material to a temperature above 50° C., 60° C., 70° C., 80° C., 90° C., 100° C., 200° C., 300° C., 400° C., 500° C., 600° C., 700° C., 800° C., 900° C., 1000° C., 1100° C., 1200° C., 1300° C., 1400° C., or 1500° C. in the presence of air, oxygen gas, hydrogen gas, nitrogen gas, argon gas, or a combination thereof.

9. The method of claim 7, wherein the material is a coating or a thin film, and treating the coating or thin film comprises contacting the coating or thin film with a chemical compound selected to increase a pH of the solution or gel.

10. The method of claim 1, further comprising:
combining the solution or gel with a chemical compound to yield solid particles; and
collecting the solid particles to yield a powder material.

11. The method of claim 1, wherein the metal oxide has an empirical formula of HₓM_{y}X_{z}O_{w} wherein H is hydrogen, M is a metal element chosen from Groups 4-6 or a doped variant thereof, X is a main group element chosen from Groups 15 and 16 or a doped variant thereof, O is oxygen, x/y ranges from 0.5 to 2, from 0.5 to 3, or from 0.5 to 6 and y/z ranges from 0.5 to 3, from 0.5 to 1, or from 0.5 to 3.

12. The method of claim 1, wherein the solution or gel comprises, in unbound form, the oxyanion, a conjugate acid of the oxyanion, or both.

13. The method of claim 1, wherein at least half of a total number of metal atoms in the metal oxide have a formal oxidation state of 4+, 5+, or 6+.

14. The method claim 1, wherein the metal oxide comprises phosphate, biphosphate, sulfate, bisulfate, or any combination thereof.

15. The method of claim 1, wherein the metal oxide comprises TiOSO₄·2H₂O or a doped variant thereof.

16. The method of claim 1, wherein the solution or gel comprises an organic polymer, and the organic polymer is soluble in the polar organic solvent.

17. The method of claim 1, wherein heating the mixture comprises heating the mixture electromagnetically, with a thermal heat flux, or both.

18. The method of claim 1, further comprising stirring, shaking, or agitating the mixture.

19. The method of claim 1, wherein a viscosity of the solution or gel at 25° C. is at least 2, 5, 10, 50, 100, 500, 1000, 5000, or 10000 times greater than a viscosity of the polar organic solvent at 25° C.

20. The method of claim 1, wherein the polar organic solvent has a dielectric constant of at least 25, 30, 35, 40, 45, 50, 55, 60, 70, 80, 90, or 100 and a dipole moment of at least 1.5 D, 2 D, 2.5 D, 3 D, 3.5 D, 4 D, or 5 D.

21. The method of claim 1, wherein the polar organic solvent comprises methanol, ethanol, formamide, N-methyl formamide, N, N-dimethyl formamide, dimethyl sulfoxide, or any combination thereof.

22. The method claim 1, wherein the metal oxide comprises TiOSO₄·2H₂O or a doped variant thereof, and the polar organic solvent comprises methanol, ethanol, formamide, N-methyl formamide, N, N-dimethyl formamide, dimethyl sulfoxide, or any combination thereof.

23. The method of claim 1, wherein the metal oxide comprises MoO₂(HPO₄)·H₂O or a doped variant thereof, and the polar organic solvent comprises formamide, N-methyl formamide, N, N-dimethyl formamide, dimethyl sulfoxide, or any combination thereof.

24. The method of claim 1, wherein the solution or gel comprises at least 0.5 wt %, 1 wt %, 5 wt %, 10 wt %, 15 wt %, 20 wt %, 25 wt %, 30 wt %, 40 wt %, 50 wt %, 60 wt %, or 70 wt % of the metal oxide.

25. The method of claim 1, wherein the solution or gel is acidic.

26. The solution or gel of claim 1.

27. The solution or gel of claim 1, wherein the solution or gel is acidic.

28. The solution or gel of claim 27, wherein the hydrogen-bonded molecular chains comprise:
one or more transition metal ions having a formal oxidation state of 4+, 5+, or 6; and
one or more oxo ligands, hydroxo ligands, aquo ligands, or any combination thereof,
wherein the polar organic solvent comprises methanol, ethanol, formamide, N-methyl formamide, N, N-dimethyl formamide, dimethyl sulfoxide, or any combination thereof.

29. A composition comprising:
the acidic solution or gel of claim 27; and
an additional material, wherein the additional material comprises an organic material, an inorganic material, a polymeric material, a biological material, a biogenic material, or any combination thereof,
wherein the additional material is soluble in the polar organic solvent.

30. A material comprising:
the composition of claim 29; and
a medium comprising an aqueous medium, an organic medium, an inorganic medium, or a polymeric medium.

31. An acidic solution or gel comprising:
a hydrate of titanyl sulfate or a doped variant thereof;
sulfuric acid; and
a polar organic solvent.

32. The acidic solution or gel of claim 31, wherein the polar organic solvent comprises methanol, ethanol, formamide, N-methyl formamide, N, N-dimethyl formamide, dimethyl sulfoxide, or any combination thereof.

33. A composition comprising:
a metal oxide, wherein the metal oxide comprises hydrogen-bonded molecular chains, and each molecular chain comprises:
a metal from Groups 4-6;
at least one oxyanion of a main group element from Groups 15 and 16 bound to the metal through a polar covalent bond, wherein the at least one oxyanion is optionally protonated; and
at least one water molecule bound to the metal through a polar covalent bond; and
a polar organic solvent.
